(19) United States
(12) Patent Application Publication
(10) Pub. No.: US 2013/0162913 A1
(43) Pub. Date: Jun. 27, 2013

(54) SIGNAL PROCESSING APPARATUS AND SIGNAL PROCESSING METHOD

(71) Applicant: Tomotaka Ida, Kumagaya-shi (JP)

(72) Inventor: Tomotaka Ida, Kumagaya-shi (JP)

(21) Appl. No.: 13/536,836

(22) Filed: Jun. 28, 2012

(30) Foreign Application Priority Data
Dec. 22, 2011 (JP) 2011-281443

(51) Int. Cl. H04N 5/44

(52) U.S. Cl. 348/734; 348/E05.096

(57) ABSTRACT

According to one embodiment, a signal processing apparatus includes a memory, an allowing module and a controller. The memory is configured to store at least one application. The allowing module is configured to allow execution operation of the application. The controller is configured to control to selectively execute one of a first application stored in the memory and a second application stored in an external device, based on the execution operation.

### CROSS-REFERENCE TO RELATED APPLICATIONS

This application is based upon and claims the benefit of priority from prior Japanese Patent Application No. 2011-281443, filed Dec. 22, 2011, the entire contents of which are incorporated herein by reference.

### FIELD

Embodiments described herein relate generally to a signal processing apparatus and a signal processing method, which control an external device.

### BACKGROUND

Various methods are used to transmit a control signal between electronic apparatuses. For example, one-way transmission IR (infrared Ray) blasters have been used between electronic apparatuses. An electronic apparatus equipped with an IR blaster receives and interprets an IR signal which is transmitted from a remote controller, generates an IR signal if necessary, and transmits the generated IR signal to another electronic apparatus.

A television apparatus and a CS (Communications Satellite) tuner device which can receive an IR signal transmitted by an IR blaster of the television apparatus will be explained as an example. When the television apparatus detects user's operation for display of an EPG (Electronic Program Guide), the television apparatus displays an EPG which is formed by using program guide data (for example, program guide data received through a network) stored (included) in the television apparatus with priority over an EPG formed by using program guide data stored in the tuner device. Therefore, in prior art, the television apparatus cannot display the EPG formed by using the program guide data stored in the tuner device with priority.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary schematic block diagram of a television apparatus according to a first embodiment.

FIG. 2 is an exemplary block diagram illustrating the television apparatus and external devices connected to the television apparatus according to the first embodiment.

FIG. 3 is an exemplary diagram illustrating an IR blaster setup picture according to the first embodiment.

FIG. 4 is an exemplary flowchart illustrating an example of EPG display processing according to the first embodiment.

FIG. 5 is an exemplary flowchart illustrating another example of EPG display processing according to a second embodiment.

### DETAILED DESCRIPTION

Various embodiments will be described hereinafter with reference to the accompanying drawings.

In general, according to one embodiment, a signal processing apparatus includes a memory, an allowing module and a controller. The memory is configured to store at least one application. The allowing module is configured to allow execution operation of the application. The controller is configured to control to selectively execute one of a first application stored in the memory and a second application stored in an external device, based on the execution operation.

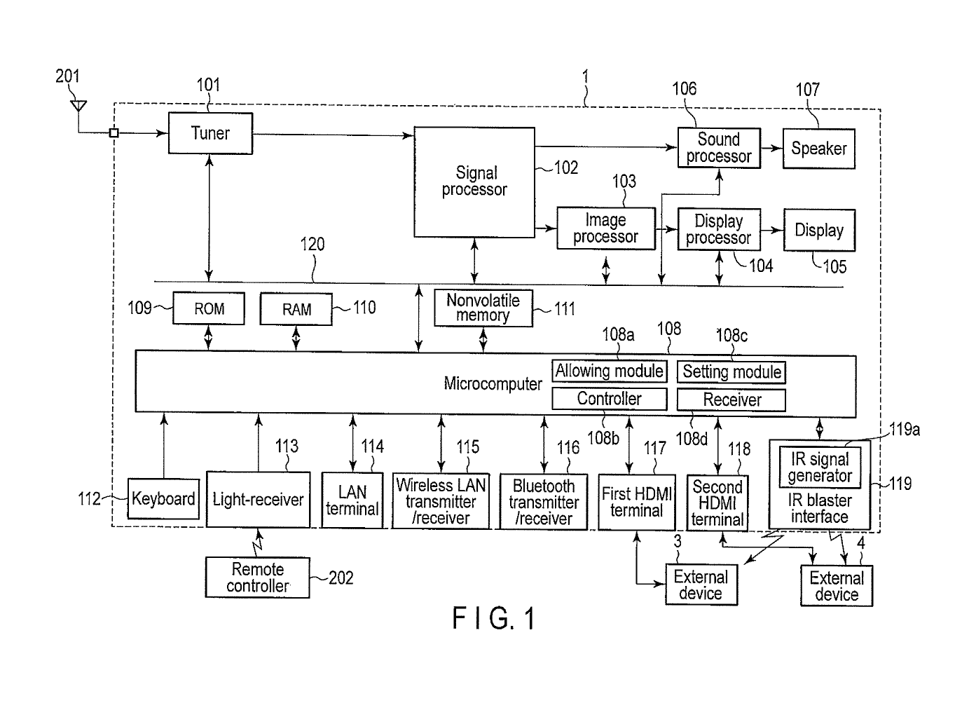

The present embodiments will be explained hereinafter with reference to drawings. FIG. 1 is a schematic block diagram illustrating a television apparatus 1 equipped with a digital broadcasting receiving tuner according to a first embodiment. The television apparatus 1 comprises a tuner 101, a signal processor 102, an image processor 103, a display processor 104, a display 105, a sound processor 106, a speaker 107, a microcomputer 108, a ROM (Read Only Memory) 109, a RAM (Random Access Memory) 110, a nonvolatile memory 111, a keyboard 112, a light-receiver 113, a LAN (Local Area Network) terminal 114, a wireless LAN transmitter/receiver 115, a Bluetooth (Registered Trademark) transmitter/receiver 116, a first HDMI (High Definition Multimedia Interface) terminal 117, a second HDMI terminal 118, and an IR blaster interface 119.

The tuner 101 selects a viewing channel designated by the user. The tuner 101 receives and demodulates a digital broadcasting signal, such as a BS (Broadcasting Satellite) signal, a CS signal, and a terrestrial digital television broadcast broadcasting signal, received by an antenna 201. The tuner 101 outputs the demodulated digital broadcasting signal to the signal processor 102. The signal processor 102 takes various digital signals out of the demodulated digital broadcasting signal. The signal processor 102 outputs an image signal to the image processor 103, and outputs a sound signal to the sound processor 106. The image processor 103 converts the image signal transmitted from the signal processor 102 into an image signal of a format which can be displayed on the display 105, and properly controls the image signal in conformity with a screen size of the display 105. The image processor 103 outputs the image signal to the display processor 104. The display processor 104 selectively superposes graphics such as character information on the image signal. For example, the display processor 104 superposes an EPG (Electronic Program guide) (Guide) on the image signal. The display processor 104 outputs the image signal to the display 105. The display 105 displays an image on the screen based on the image signal.

The sound processor 106 processes the sound signal transmitted from the signal processor 102 into a sound signal of a format which can be played back by the speaker 107, and amplifies the sound signal. The sound processor 106 outputs the sound signal to the speaker 107. The speaker 107 outputs sound based on the sound signal. The user can view an image of a desired program on the display 105, and hear sound of the desired program from the speaker 107.

The microcomputer 108 controls operation of the modules/elements of the television apparatus 1, and transmits and receives data to/from the modules/elements. For example, the microcomputer 108 is connected with the tuner 101, the signal processor 102, the image processor 103, the display processor 104, and the sound processor 106, through a communication line 122 (for example, TIC (Inter-IC)-BUS). The ROM 109 stores a control program which is executed by the microcomputer 108. The RAM 110 provides the microcomputer 108 with a work area. The nonvolatile memory 111 stores various information items and data. For example, the nonvolatile memory 111 stores program guide data. The nonvolatile memory 111 stores at least one application. For example, the nonvolatile memory 111 stores an EPG application to form (generate) an EPG to be displayed on the display 105 by using the program guide data. The keyboard 112 receives user operation. The light-receiver 113 receives an IR signal generated by operation of a remote controller 202 by the user.

The LAN terminal 114 is connected to an external or internal network through a LAN (Ethernet (Registered Trademark)). The wireless LAN transmitter/receiver 115 is connected to an external or internal network through a wireless LAN. The LAN terminal 114 and the wireless LAN transmitter/receiver 115 are connected with external devices (connection devices) through a network.

The Bluetooth transmitter/receiver 116 is connected to an external device through Bluetooth. The first HDMI terminal 117 is connected to an external device through an HDMI cable. The second HDMI terminal 118 is connected to an external device through an HDMI cable. Specifically, the LAN terminal 114, the wireless LAN transmitter/receiver 115, the Bluetooth transmitter/receiver 116, the first HDMI terminal 117, and the second HDMI terminal 118 are external input terminals which function as interfaces connected to external devices. Therefore, the microcomputer 108 can receive information (such as image information and sound information) from the external devices that are connected to the LAN terminal 114, the wireless LAN transmitter/receiver 115, the Bluetooth transmitter/receiver 116, the first HDMI terminal 117, and the second HDMI terminal 118.

In the first embodiment, suppose that the first HDMI terminal 117 is connected to an external device 3 through the HDMI cable, and the second HDMI terminal 118 is connected to an external device 4 through the HDMI cable. The nonvolatile memory 111 registers and stores connection of the external device 3 to the first HDMI terminal 117 (also referred to as HDMI 1) being an external input terminal. In the same manner, the nonvolatile memory 111 registers and stores connection of the external device 4 to the second HDMI terminal 118 (also referred to as HDMI 2) being an external input terminal. Although FIG. 1 shows one LAN terminal and two HDMI terminals, the numbers of the terminals are not limited to them.

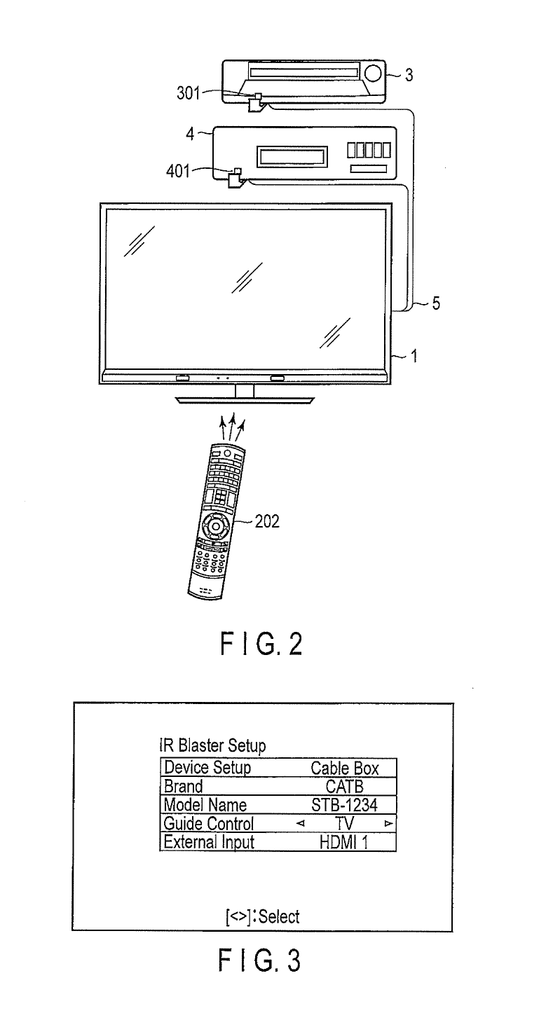

The IR blaster interface 119 is connected to one end of an IR blaster cable 5, as explained later with reference to FIG. 2. The IR blaster interface 119 functions as an interface which is connected to an external device through the IR blaster cable 5, unlike the external input terminals. The IR blaster interface 119 has a signal generator (IR blaster) 119a. The IR signal generator 119a generates an IR signal (control signal), and transmits the IR signal to the external devices 3 and 4 through the IR blaster interface 119. The microcomputer 108 controls the external devices 3 and 4 by the IR signal generated by the IR signal generator 119a.

FIG. 2 is a block diagram which schematically illustrates the television apparatus 1 and the external devices 3 and 4 that are connected to the television apparatus 1. The external devices 3 and 4 are devices which has IR sensors 301 and 401, respectively, and can be controlled by IR signals. The external device 3 is, for example, a cable box. The external device 4 is, for example, an audio apparatus. The IR blaster interface 119 is connected with one end of a control line which is referred to as IR blaster cable 5. In the example illustrated in FIG. 2, the other end of the IR blaster cable 5 is divided into two, since the television apparatus 1 controls both the external device 3 and the external device 4.

The other end of the IR blaster cable 5 is set to be opposed to the IR sensor 301 of the external device 3 and the IR sensor 401 of the external device 4. Specifically, the IR signal generator (transmitter) 119a transmits an IR signal to the IR sensor 301 of the external device 3 and the IR sensor 401 of the external device 4, through a route which is different from the route of passing through the first HDMI terminal 117 or the second HDMI terminal 118. By the above structure, the television apparatus 1 can control the external device 3 and the external device 4, by an IR signal generated by the IR signal generator 119a.

Specifically, the user can control each of the external device 3 and the external device 4 connected to the first HDMI terminal 117 and the second HDMI terminal 118 being external input terminals, only by operating the remote controller 202 pointed toward the television apparatus 1. Thereby, the user can control each of the external device 3 and the external device 4, as if the user pushed down the buttons of the remote controllers of the external device 3 or the external device 4.

Next, IR blaster setup in the television apparatus 1 will be explained hereinafter. As an example, the user can perform setting for each external input terminal, about which of an EPG function of the television apparatus 1 and an EPG function of the external device is to be executed by pushing down a Guide key of the remote controller 202 to display an EPG on the display 105, as IR blaster setting. The microcomputer 108 performs the EPG function of the television apparatus 1 as follows. When the EPG function is executed, the microcomputer 108 (receiver) receives (obtains) program guide data from an external network (Internet) through the LAN terminal 114 or the wireless LAN transmitter/receiver 115. The microcomputer 108 stores the received program guide data in the nonvolatile memory 111. Thereafter, the microcomputer 108 executes (starts) an EPG application, forms an EPG by using the program guide data stored in the nonvolatile memory 111, and controls to display the EPG on the display 105. Although the microcomputer 108 receives the program guide data from the external network when it executes the EPG application, the microcomputer 108 may receive the program guide data in advance from the external network, and store the program guide data in the nonvolatile memory 111. On the other hand, the external device executes the EPG function of the external device as follows. When the EPG function is executed, the external device executes an EPG application stored (included) in the external device, and forms an EPG by using program guide data stored in the external device. Then, the external device transmits the EPG to the television apparatus 1, to display the EPG on the display 105 of the television apparatus 1. The microcomputer 108 controls to display the EPG received from the external device on the display 105. The EPG application stored in the nonvolatile memory 111 is of the same type as the EPG application stored in the external device.

FIG. 3 is a diagram of a picture of an example of IR blaster setup for the HDMI 1 which is an external input terminal, to (for) which the external device 3 is connected (registered). The user can perform external device registration for each external input terminal, on the IR blaster setup picture. The item “Device Setup” in the IR blaster setup picture shows “Cable Box” as a device type of the external device 3 registered for the HDMI 1. The item “Brand” shows “CATS” which is the brand name of the external device 3 connected to HDMI 1. The item “Model Name” shows “STB-1234” which is a model name of the external device 3 registered for the HDMI 1. The item “Guide Control” selectively shows a device (“TV” or “External Device”) which stores the EPG application that executes the EPG function to display an EPG. Specifically, the user can select which of the EPG application stored in the television apparatus 1 and the EPG application stored in the external device is to be executed. The item “External Input” shows “HDMI 1” which is the external input terminal, for which the external device 3 is registered. The microcomputer 108 (setting module 108c) performs setting, based on user operation, about which of the EPG application stored in the television apparatus 1 and the EPG application stored in the external device is to be executed, and stores IR blaster setting including the setting in the nonvolatile memory 111. IR blaster setting for the HDMI 2 which is the external input terminal connected with the external device 4 is the same as the above, and explanation thereof is omitted.

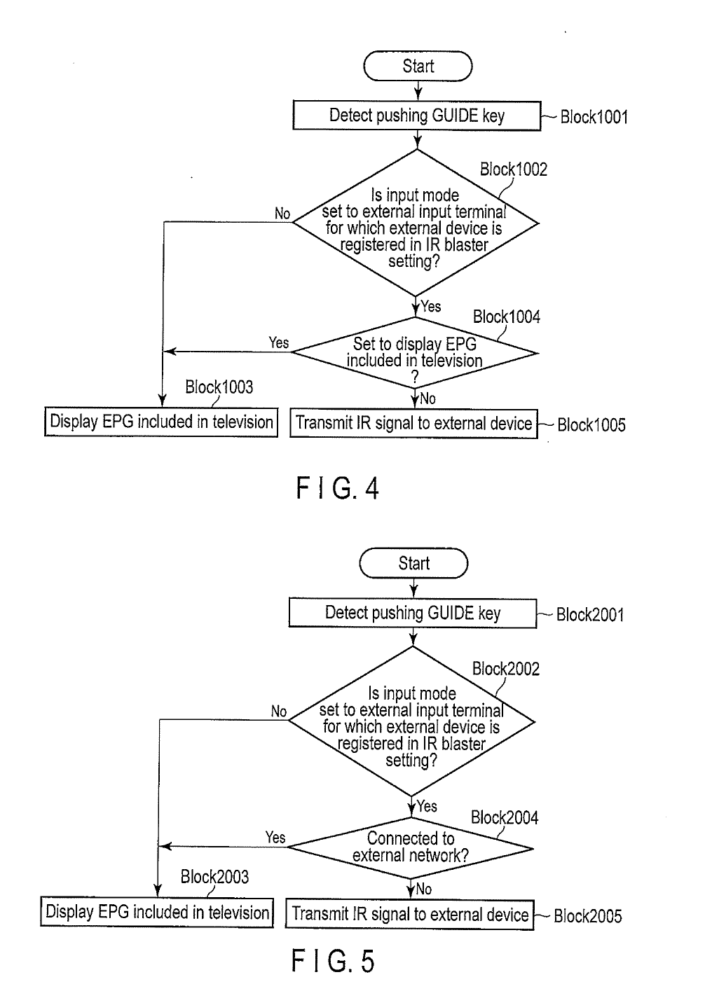

Next, processing of displaying an EPG in the television apparatus 1 according to the first embodiment will be explained hereinafter. FIG. 4 is a flowchart illustrating an example of the processing. First, the microcomputer 108 detects pushing the GUIDE key of the remote controller 202 by operation by the user (Block 1001). Specifically, at Block 1001, the microcomputer 108 (allowing module 108a) allows execution operation of the application by the user. Pushing the GUIDE key is one (one-time) execution operation to execute the application.

The microcomputer 108 determines whether the current input mode is set to an external input terminal, for which an external device is registered in the IR blaster setting (Block 1002). The term “input mode” indicates an input source which inputs a signal for which the microcomputer 108 controls to display an image on the display 105. For example, the input mode is “TV” when the image to be displayed is based on a digital broadcasting signal inputted through the tuner 101, the input mode is “HDMI 1” when the image to be displayed is based on a signal inputted through the first HDMI terminal 117, and the input mode is “HDMI 2” when the image to be displayed is based on a signal which is inputted through the second HDMI terminal 118. The microcomputer 108 changes the input mode by operation of switching the input mode by the user. Specifically, at Block 1002, the microcomputer 108 (controller 108b) determines whether the current external input is made through the HDMI 1 or the HDMI 2.

When the current input mode is not set to any external input terminal, for which an external device is registered in the IR blaster setting (i.e., the current external input is not made through the HDMI 1 or the HDMI 2) (Block 1002, No), the microcomputer 108 controls to display the EPG included in the television on the display 105 (Block 1003). Specifically, at Block 1003, the microcomputer 108 (receiver 108d) receives program guide data to be used by the EPG application stored in the television apparatus 1 from the external network, by the EPG function of the television apparatus 1. Then, the microcomputer 108 (controller 108b) executes the EPG application stored in the television apparatus 1, and controls to display an EPG based on the EPG application stored in the television apparatus 1 on the display 105 by using the program guide data. The microcomputer 108 may use program guide data which is received from the external network in advance and stored in the nonvolatile memory 111. The microcomputer 108 may use program guide data which is included in the digital broadcasting signal obtained through the tuner 101.

When the current input mode is set to an external input terminal, for which an external device is registered in the IR blaster setting (i.e., the current external input is made through the HDMI 1 or the HDMI 2) (Block 1002, Yes), the microcomputer 108 determines whether the IR blaster setting of the external input terminal which corresponds to the current input mode is set to display an EPG included in the television (Block 1004). Specifically, at Block 1004, the microcomputer 108 determines whether the item “Guide Control” in the IR blaster setting is set to “TV”. When the IR blaster setting is set to display an EPG included in the television (Block 1004, Yes), the microcomputer 1008 performs processing of Block 1003. Specifically, when the IR blaster setting is set to display the EPG included in the television, the microcomputer 108 operates the EPG function of the television apparatus 1 with priority over the EPG function of the external device. Therefore, the microcomputer 108 outputs no IR signals from the IR signal generator 119a to the external device through the IR blaster cable 5.

When the IR blaster setting is not set to display the EPG included in the television (Block 1004, No), the microcomputer 108 controls to output an IR signal from the IR signal generator 119a to the external device through the IR blaster cable 5 (Block 1005). The IR signal includes a command to request (prompt) execution of the EPG application stored in the external device 3. When the external device receives the IR signal including the command, the external device executes the EPG function of the external device as explained above. Then, the microcomputer 108 receives an EPG based on the EPG application stored in the external device, and controls to display the EPG on the display 105.

According to the first embodiment, the microcomputer 108 (controller 108b) controls to selectively execute one of the EPG application (EPG function of the television apparatus 1) stored in the television apparatus 1 (nonvolatile memory 111) and the EPG application (EPG function of the external device) stored in the external device, based on execution operation of the application (one execution operation to execute the application) by the user. When the current external input is made through the HDMI 1 or the HDMI 2, the microcomputer 108 (controller 108b) controls to selectively execute one of the EPG application stored in the television apparatus 1 and the EPG application stored in the external device, based on the IR blaster setting provided by the microcomputer 108 (setting module 108c) by user setting. This structure improves the user's convenience.

Next, a second embodiment will be explained hereinafter. The structures of a television apparatus 1 and external devices 3 and 4 connected to the television apparatus 1 according to the second embodiment are the same as those of the first embodiment, and explanation thereof is omitted. The second embodiment is an example in which IR blaster setup is not performed for each external input terminal, unlike the setup picture illustrated in FIG. 3. FIG. 5 is a flowchart illustrating an example of processing of displaying an EPG in the television apparatus 1 according to the second embodiment. First, a microcomputer 108 detects pushing a GUIDE key of a remote controller 202 by operation by the user (Block 2001). Specifically, at Block 2001, the microcomputer 108 performs the same processing as Block 1001. The microcomputer 108 determines whether the current input mode is set to an external input terminal, for which an external device is registered in the IR blaster setting (Block 2002). Specifically, at Block 2002, the microcomputer 108 performs the same processing as Block 1002.

When the current input mode is not set to any external input terminal, for which an external device is registered in the IR blaster setting (i.e., the current external input is not made through the HDMI 1 or the HDMI 2) (Block 2002, No), the microcomputer 108 controls to display an EPG included in the television on a display 105 (Block 2003). Specifically, at Block 2003, the microcomputer 108 performs the same processing as Block 1003. When the current input mode is set to an external input terminal, for which an external device is registered in the IR blaster setting (i.e., the current external input is made through the HDMI 1 or the HDMI 2) (Block 2002, Yes), the microcomputer 108 determines whether the television apparatus 1 is connected to an external network (Block 2004). Specifically, at Block 2004, the microcomputer 108 (controller 108b) determines whether a LAN terminal 114 or a wireless LAN transmitter/receiver 115 is connected to an external network.

When the television apparatus 1 (the LAN terminal 114 or the wireless LAN transmitter/receiver 115) is connected to an external network (Block 2004, Yes), the microcomputer 108 performs processing of Block 2003. Specifically, in the state where the television apparatus 1 is connected to an external network, the microcomputer 108 operates an EPG function of the television apparatus 1 with priority over an EPG function of the external device. Therefore, the microcomputer 108 outputs no IR signals from an IR signal generator 119a to the external device through an IR blaster cable 5.

When the television apparatus 1 (the LAN terminal 114 or the wireless LAN transmitter/receiver 115) is not connected to any external network (Block 2004, No), the microcomputer 108 controls to output an IR signal from the IR signal generator 119a to the external device through the IR blaster cable 5 (Block 2005). Specifically, the microcomputer 108 controls to execute an EPG application stored in the external device. When the external device receives the IR signal, the external device executes the EPG function of the external device as explained above. Then, the microcomputer 108 receives an EPG based on the EPG application stored in the external device, and controls to display the EPG on the display 105. Specifically, the microcomputer 108 can perform control to display an EPG formed by the EPG function of the external device on the display 105, even when the EPG function of the television apparatus 1 cannot be operated since the television apparatus 1 is not connected to the external network.

According to the second embodiment, the microcomputer 108 (controller 108b) controls to selectively execute one of an EPG application (EPG function of the television apparatus 1) stored in the television apparatus 1 (a nonvolatile memory 111) and the EPG application stored in the external device, according to whether the television apparatus 1 (the LAN terminal 114 or the wireless LAN transmitter/receiver 115) is connected to an network. This structure improves the user's convenience.

Although the microcomputer 108 in the present embodiment transmits an IR signal which includes a command to request execution of the EPG application stored in the external device to the external device, the present embodiment is not limited to this structure. For example, the microcomputer 108 may transmit an IR signal, which includes a command to request transmission of program guide data itself stored in the external device, to the external device. When the external device receives the IR signal including the command, the external device transmits the program guide data itself to the television apparatus 1. Specifically, the external device does not execute the EPG application, or form an EPG by using program guide data information. Although the microcomputer 108 executes an EPG application stored in the nonvolatile memory 111, the microcomputer 108 forms an EPG by using program guide data received from the external device, without using the program guide data stored in the nonvolatile memory 111, and displays the EPG on the display 105. Specifically, the microcomputer 108 (controller 108b) controls to execute the EPG application stored in the nonvolatile memory 111 and forms an EPG, by selectively using one of the program guide data stored in the television apparatus 1 (nonvolatile memory 111) and the program guide data stored in the external device, based on pushing (execution operation) the GUIDE key by the user. In this case, although the microcomputer 108 transmits an IR signal after Block 1004 or Block 2004, the timing of transmitting an IR signal is not limited to this structure. For example, the microcomputer 108 may receive in advance program guide data stored in the external device, and store the program guide data in the nonvolatile memory 111 as program guide data of the external device.

The microcomputer 108 may perform processing obtained by combining the first embodiment with the second embodiment. For example, the microcomputer 108 may perform the processing of Block 1004 after the processing of Block 2002 and before the processing of Block 2004. In addition, although the television apparatus 1 in the present embodiment transmits a control signal to the external device by the IR blaster, a control signal may be transmitted to the external device by using another communication module. In addition, although the television apparatus 1 receives an EPG by controlling the external device connected to the HDMI terminal, the television apparatus 1 can receive an EPG by controlling an external device connected to another external input terminal in the same manner.

Although the present embodiment shows an example of using an EPG as information to be controlled, the present embodiment is not limited to it. For example, the information to be controlled may be channel up/down information, browser information, or recording list information. When the information to be controlled is channel up/down information, the microcomputer 108 selectively controls one of the channel up/down of the television apparatus 1 and channel up/down of the external device, in accordance with the IR blaster setting. When the information to be controlled is browser information or recording list information, the microcomputer 108 selectively displays the browser or the recording list of the television apparatus 1 or the external device on the display 105.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A signal processing apparatus comprising:
a first interface configured to be connected to an external device so as to receive information from the external device;
a second interface configured to be different from the first interface and configured to be used to transmit a control signal to the external device;
a transmitter configured to transmit the control signal to the external device through the second interface;
a memory configured to store at least one application;
a first receiver configured to receive an execution operation of an application as a user operation from a remote controller; and
a controller configured to control to execute a first application stored in the memory or configured to control to cause the transmitter to transmit, to the external device, the control signal to request execution of a second application stored in the external device, depending on whether an image on a display at the execution operation is an image based on a signal inputted through a tuner or an image based on a signal inputted through the first interface.

2. (canceled)

3. The apparatus of claim 1, further comprising:
the display; and wherein
the controller displays an electronic program guide generated based on the first application, or an electronic program guide generated base on the second application and received from the external device through the first interface.

4. The apparatus of claim 1, wherein
the transmitter transmits an IR signal as the control signal.

5. (canceled)

6. The apparatus of claim 1, further comprising:
a setting module configured to perform setting, based on a setting operation for an application as the user operation received by the first receiver, about which of the first application and the second application is to be executed.

7. The apparatus of claim 6, wherein
the controller executes one of the first application and the second application, based on the setting by the setting module, when the image on the display at the execution operation is the image based on the signal inputted through the first interface.

8. The apparatus of claim 1, comprising:
a third interface; and wherein
the controller determines whether a third interface is connected to internet so as to obtain information, when the image on the display at the execution operation is the image based on the signal inputted through the first interface.

9. The apparatus of claim 8, wherein
the controller controls to execute the first application, when the third interface is connected to internet.

10. The apparatus of claim 9, further comprising:
a second receiver configured to receive information that is to be used by the first application through the third interface.

11. The apparatus of claim 8, wherein
the controller controls to execute the second application, when the third interface is not connected to internet.

12. A signal processing method at the signal processing apparatus comprising a first interface configured to be connected to an external device so as to receive information from the external device, a second interface configured to be different from the first interface and configured to be used to transmit a control signal to the external device, and a memory configured to store at least one application, the method comprising:
receiving an execution operation of an application from a remote controller; and
controlling to execute a first application stored in the memory or controlling to transmit, to the external device, the control signal to request execution of a second application stored in the external device, depending on whether an image on a display at the execution operation is an image based on a signal inputted through a tuner or an image based on a signal inputted through the first interface.

13. A signal processing apparatus, comprising:
a first interface configured to be connected to an external device so as to receive information from the external device;
a second interface configured to be different from the first interface and configured to be used to transmit a control signal to the external device;
a transmitter configured to transmit the control signal to the external device through the second interface;
a memory configured to store data and application;
a receiver configured to receive an execution operation of the application as a user operation from a remote controller; and
a controller configured to control to execute the application by using the data stored in the memory, or configured to cause the transmitter to transmit, to the external device through the second interface, the control signal to request to send data stored in the external device to the signal processing apparatus and configured to control to execute the application by using data stored in the external device and received through the first interface, depending on whether an image on a display at the execution operation is an image based on a signal inputted through a tuner or an image based on a signal inputted through the first interface.
